(19) United States
(12) Patent Application Publication
(10) Pub. No.: US 2026/0186757 A1
(43) Pub. Date: Jul. 2, 2026

(54) TIME-AWARE ROLLOUTS FOR CLOUD SOFTWARE

(71) Applicant: Confluent, Inc., Mountain View, CA (US)

(72) Inventors: Gopi K. Attaluri, Pleasanton, CA (US); Jiahua Yan, Santa Clara, CA (US); Keshav Mathur, Santa Clara, CA (US)

(21) Appl. No.: 19/006,561

(22) Filed: Dec. 31, 2024

(51) Int. Cl. G06F 8/60; G06F 9/50

(52) U.S. Cl. CPC G06F 8/60; G06F 9/505; G06F 2209/5019

(57) ABSTRACT

Cloud software provides services to client devices and other cloud software. During a period of time in which cloud software is being rolled out, such as during an upgrade, the performance of the software may be degraded, or the software may even be offline during the rollout. A workload of the cloud software over a previous period of time is analyzed and used to determine a rollout window. The rollout window is a period of time during which the expected usage of the cloud software is relatively low. Accordingly, the disruptive effect of the rollout is reduced in comparison with systems that do not determine a rollout window based on usage data.

### TECHNICAL FIELD

The subject matter disclosed herein generally relates to rollouts of cloud software. Specifically, the present disclosure addresses systems and methods for time-aware rollouts for cloud software.

### BACKGROUND

When cloud software is deployed, the deployment may affect the functioning of cloud services and applications that depend on the cloud software. Typically, an administrator chooses when to perform the deployment.

### BRIEF DESCRIPTION OF THE DRAWINGS

Some embodiments are illustrated by way of example and not limitation in the figures of the accompanying drawings.

FIG. 1 is a diagram illustrating relationships among a broker provider, cloud service providers, realms, and networks, according to some example embodiments.

FIG. 2 is a diagram illustrating relationships among a network, container environments, physical clusters, and logical clusters, according to some example embodiments.

FIG. 3 is a diagram of a database schema including an historic usage table, according to some example embodiments.

FIG. 4 is a diagram of resource consumption data for each hour of each day of two weeks, according to some example embodiments.

FIG. 5 is a diagram of relative resource consumption data, according to some example embodiments.

FIG. 6 is a flowchart illustrating operations of a method for determining a rollout window for cloud software and deploying the cloud software, according to some example embodiments.

FIG. 7 is a flowchart illustrating operations of a method for determining a rollout window for cloud software, according to some example embodiments.

FIG. 8 is a flowchart illustrating operations of a method for determining a rollout window for cloud software, according to some example embodiments.

FIG. 9 is a block diagram illustrating components of a machine, according to some example embodiments, able to read instructions from a machine-storage medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

In order to flow data from an on-premises cluster to the cloud, applications or brokers running in the cloud need to establish a connection to the on-premises cluster to be able to fetch the data from the on-premises cluster. The cloud comprises a network of servers that are accessible over the Internet, and the software and databases that run on those servers.

When a resource is being deployed to the cloud, there are many possible locations for the deployment. For example, an application is executed by processors and memory in a physical cluster. The physical cluster may handle many tasks, which may be divided into logical clusters. The physical cluster is one of several physical clusters that are managed by a management system such as Kubernetes™, Nomad™, or Elastic Container Service™ (ECS). The management system executes within a network, such as a US network, a European network, or an Asian network of a cloud provider, such as Amazon Web Services™ (AWS), Microsoft Azure™, or Google Cloud Platform™. A customer of the cloud provider may use multiple accounts, referred to as realms, each of which may access one or more networks of the cloud provider.

As used herein, the generic term for a realm, network, management system, physical cluster, logical cluster, or application is “resource.” When a resource is created, it is placed under a parent resource. Some resources have a dedicated placement that specifies a particular parent resource. Other resources are shared, and placement of the resource is performed based on information about the resource to be placed and the available parent resources.

Cloud software, such as is Apache Kafka®, provides services to client devices and other cloud software. During a period of time in which cloud software is being rolled out, such as during an upgrade, the performance of the software may be degraded, or the software may even be offline during the rollout.

As disclosed herein, a workload of the cloud software over a previous period of time is analyzed and used to determine a rollout window. The rollout window is a period of time during which the expected usage of the cloud software is relatively low. Accordingly, the disruptive effect of the rollout is reduced in comparison with systems that do not determine a rollout window based on usage data.

The rollout window may be determined by considering multiple candidate rollout windows of a predetermined size. For each candidate rollout window, a workload of the cloud software is determined for the same day of one or more previous weeks. Based on the workload data for the candidate rollout windows, a rollout window is selected. The cloud software is deployed during the selected rollout window.

Thus, example embodiments address the technical problem of how to efficiently roll out cloud software. To address the technical problem, example embodiments utilize historic workload data. As a result, example embodiments provide a technical solution that, among other things, reduces the operational burden of rolling out cloud software by improving the flexibility and reliability of the system.

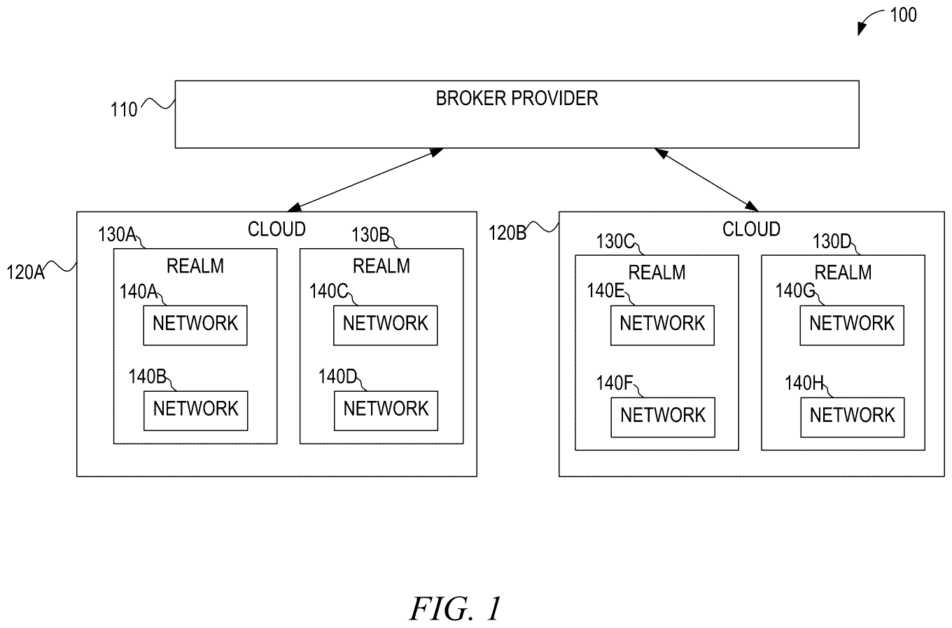

FIG. 1 is a diagram 100 illustrating relationships among a broker provider 110; cloud service providers 120A and 120B; realms 130A, 130B, 130C, and 130D; and networks 140A, 140B, 140C, 140D, 140E, 140F, 140G, and 140H, according to some example embodiments. The various elements of FIG. 1 may be referenced by number alone. For example, “a cloud service provider 120” may be used to refer generically to either of the cloud service providers 120A-120B and “the cloud service providers 120” may be used to refer to the cloud service providers 120A-120B collectively. Similarly, “a realm 130” may be used to refer generically to any of the realms 130A-130D and “the realms 130” may be used to refer to the realms 130A-130D collectively. Likewise, “a network 140” may be used to refer generically to any of the networks 140A-140H and “the networks 140” may be used to refer to the networks 140A-140H collectively.

The broker provider 110 provides services using applications running on hardware computing resources of one or more cloud service providers 120. To access the cloud service providers 120, the broker provider 110 may use multiple accounts, each account having different access credentials (e.g., username and password). The realms 130 represent these separate methods of accessing the cloud service providers 120.

The cloud service provider 120 may provide access to multiple networks 140, such as a US network, a European network, and an Asian network. In addition to, or instead of, being divided by geography, networks may be divided by functionality. For example, the network 140A may provide access to artificial intelligence (AI) tools and the network 140B may not. After connecting to a cloud service provider 120 with an account, thus defining a realm 130, applications are deployed to hardware computing resources of a particular network 140.

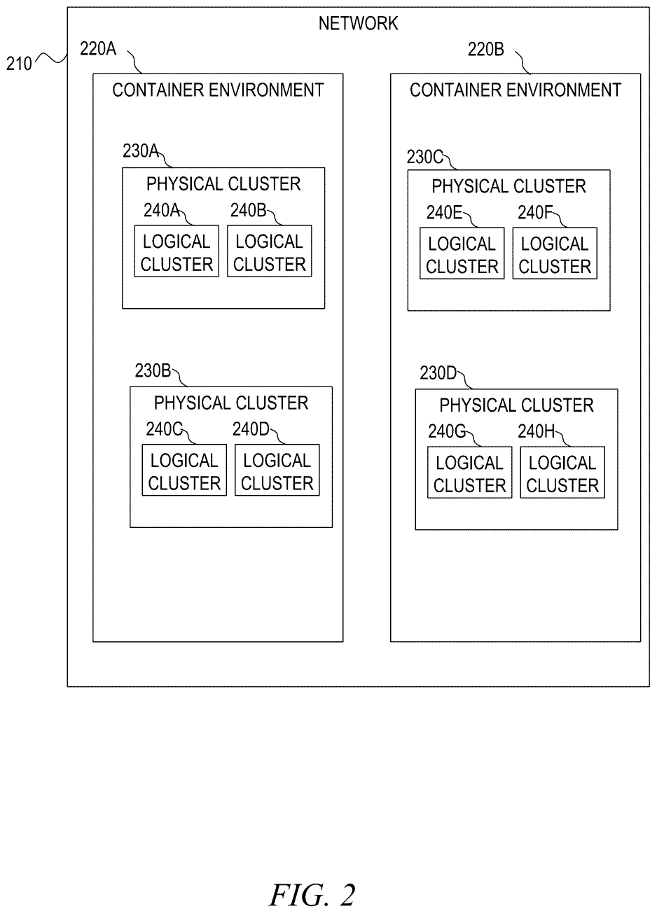

FIG. 2 is a diagram illustrating relationships among a network 210; container environments 220A and 220B; physical clusters 230A, 230B, 230C, and 230D; and logical clusters 240A, 240B, 240C, 240D, 240E, 240F, 240G, and 240H, according to some example embodiments. The various elements of FIG. 2 may be referenced by number alone. For example, “a logical cluster 240” may be used to refer generically to any of the logical clusters 240A-240H and “the logical clusters 240” may be used to refer to the logical clusters 240A-240H collectively.

The network 210 may include multiple container environments 220. For example, the container environments 220A may be separate Kubernetes clusters. The container environments 220 may each make use of multiple physical clusters 230. A physical cluster 230 comprises the actual physical computing hardware on which the application will run. The resources of a physical cluster 230 may be divided into multiple logical clusters 240. Thus, even though two containerized applications of the container environment 220A may execute on the same physical cluster 230A, they may execute in different logical clusters 240A, 240B.

As can be seen from FIGS. 1 and 2, the determination of where to deploy an application may be a complex one. The exact cloud service provider 120, realm 130, network 140, container environment 220, physical cluster 230, and logical cluster 240 may be defined by an administrator for each deployed application for static deployments. However, dynamic deployments make use of algorithmic determinations in order to reduce delay. The complexity of deployment for applications applies equally well to intermediate resources. For example, if a new container environment 220 is to be provisioned, there are many choices as to the particular cloud service provider 120, realm 130, and network 140.

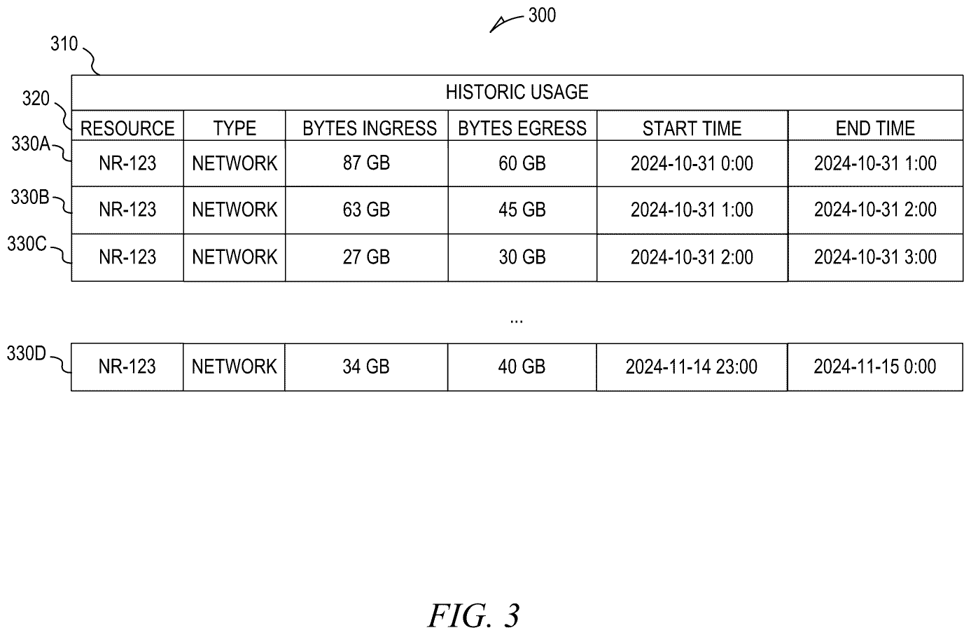

FIG. 3 is a diagram of a database schema 300 including an historic usage table 310, according to some example embodiments. The historic usage table 310 includes rows 330A, 330B, 330C, and 330D of a format 320. By way of example, four rows 330A-330D are shown, but the historic usage table may include one row for each period of time for each resource in the system. For example, resource usage data for each cluster may be stored for each hour of each day of the past three weeks, with data for one hour stored in each row. In this example, the historic usage table 310 would store 24 entries per day times 7 days per week times 3 weeks equals 504 rows per cluster. Thus, in a system with thousands of clusters, the historic usage table 310 may include millions of rows, an amount of data far beyond the ability of a human mind to process.

As indicated by the format 320, each of the rows 330A-330D includes an identifier of a resource, a type of the resource, usage data for the resource (e.g., bytes ingress and egress during a period of time), a start time for the usage data, and an end time for the usage data. In various example embodiments, different or additional usage data may be stored (e.g., maximum CPU and memory usage).

Thus, the row 330A contains historic usage data for the network resource NR-123. During the period of time of 10:00 on Oct. 31, 2024 to 11:00 on Oct. 31, 2024, the bytes ingress of the network resource NR-123 was 87 GB. During the same period of time, the bytes egress was 60 GB.

The row 330B contains historic usage data for the same resource during the following one hour period of time. During this period of time, the bytes ingress was 63 GB and the bytes egress was 45 GB.

Historic usage data for the next period of time is stored in the row 330C. During this period of time, the bytes ingress was 27 GB and the bytes egress was 30 GB. Some rows are omitted after the row 330C. During the last hour of Nov. 14, 2024, the bytes ingress was 34 GB and the bytes egress was 40 GB.

By analyzing the historic usage data, the broker provider 110 of FIG. 1 is enabled to determine a rollout window for cloud software that is likely to minimize the impact of the rollout on client services.

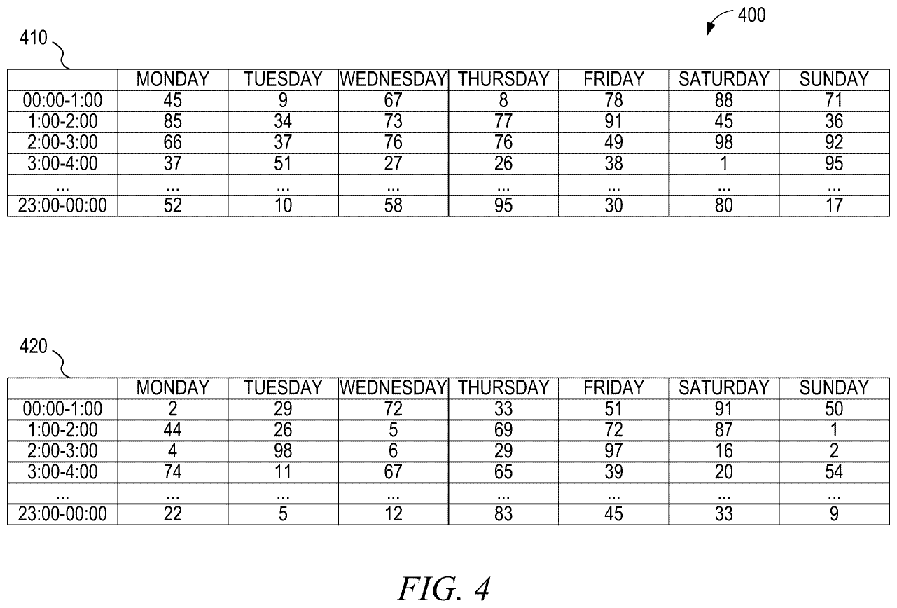

FIG. 4 is a diagram 400 of resource consumption data for each hour of each day of two weeks, according to some example embodiments. The table 410 shows a resource consumption score for a resource for each hour of a first week. The table 420 shows a resource consumption score for the resource for each hour of a second week.

The resource consumption score for each time period is based on resource consumption data for the resource for the time period. In various example embodiments, the method of determining the resource consumption score differs. For example, the resource consumption score may be equal to the bytes ingress during the period of time, equal to the bytes egress during the period of time, equal to the sum of the bytes ingress and the bytes egress during the period of time, equal to the maximum CPU consumption during the period of time, equal to the average CPU consumption during the period of time, equal to the maximum memory usage during the period of time, equal to the average memory usage during the period of time, equal to a weighted average of maximum CPU consumption and average memory usage, or any suitable combination thereof.

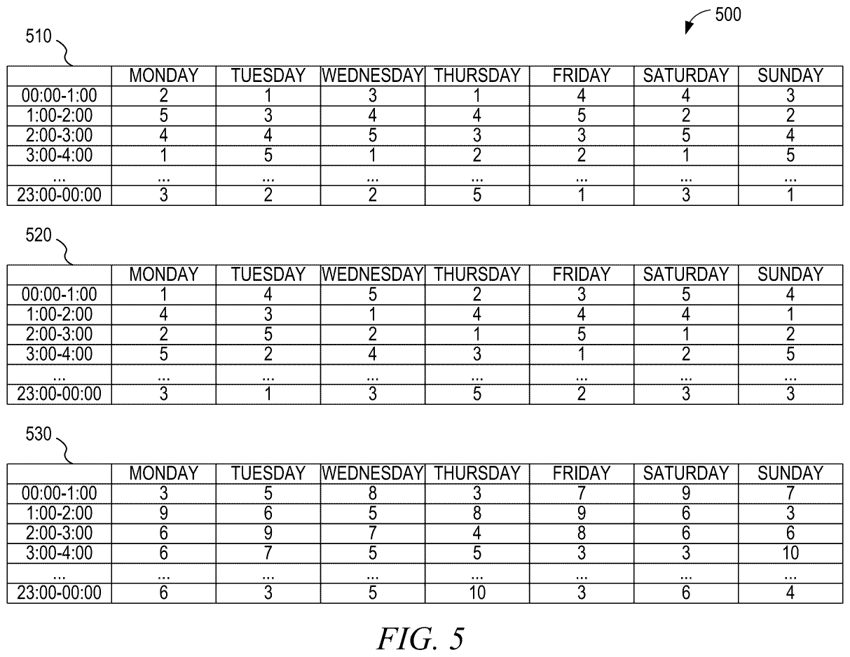

FIG. 5 is a diagram 500 of relative resource consumption data, according to some example embodiments. The table 510 is based on the data of the table 410 of FIG. 4. The table 520 is based on the data of the table 420 of FIG. 4.

In FIG. 4, the tables 410 and 420 show resource consumption scores. In FIG. 5, the tables 510 and 520 show resource consumption ranks. Within each day of each week, the time period that has the lowest resource consumption score is given the rank of 1. The time period with the next lowest resource consumption score is given the rank of 2, and so on. In the examples of FIGS. 4 and 5, each time period is one hour and there are twenty-four time periods in each day. Accordingly, for each day, the ranks are in the range of 1-24.

The table 530 is generated by summing the ranks of corresponding time periods of two or more weeks. For example, the rank of the time period 00:00-1:00 on Monday in the table is 3 because the rank of the same time period in the week of the table 510 is 2 and the rank of the same time period in the week of the table 520 is 1. Thus, the ranking shown in the table 530 takes into account the usage data of multiple previous weeks.

For example, based just on the data from the table 510 for a resource, it would appear that the best time period to rollout cloud software to the resource would be from 3:00-4:00, since this time period has rank 1. However, the table 520 shows that during the same time period for the same resource in a different week, this time period has rank 5. Thus, this time period has an equal likelihood, based on historic data, of being a high-usage time period or being a low-usage time period. Instead, it is the time period of 00:00-1:00, which was not the lowest-usage time period in the week of the table 510, that consistently had relatively low usage.

For each day of the week in the table 530, a time period having the lowest ranking may be selected as a rollout period for cloud software to the resource. In some example embodiments, the top two or top three time periods are selected based on their rankings and another algorithm is used to select between them.

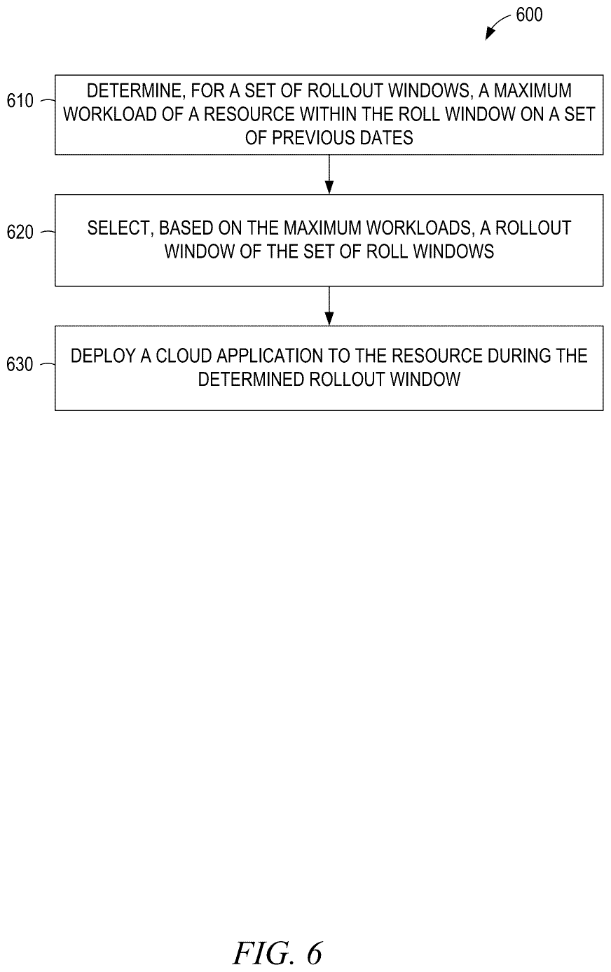

FIG. 6 is a flowchart illustrating operations of a method 600 for determining a rollout window for cloud software and deploying the cloud software, according to some example embodiments. The method 600 includes operations 610, 620, and 630. By way of example and not limitation, the method 600 is described as being performed by the broker provider 110 of FIG. 1, in communication with the cloud service providers 120A-120B, realms 130A-130D, networks 140A-140H, container environments 220A-220B, physical clusters 230A-230D, and logical clusters 240A-240H, of FIGS. 1-2. The broker provider 110 uses the data structures of FIGS. 4-5. Prior to performing the method 600, historic usage data for a cloud application may be stored in a database, such as the database schema 300 of FIG. 3.

In operation 610, the broker provider 110 determines, for a set of rollout windows, a maximum workload of a resource within the rollout window on a set of previous dates. For example, the set of rollout windows may be defined as twenty-four non-overlapping one-hour periods of a day. The set of previous dates may be defined as the days 7, 14, and 21 days before the day. In various example embodiments, the set of previous dates may be larger or smaller (e.g., two dates, four dates, or ten dates). In this example, the previous dates have the same day of week as the day of the rollout windows. In other examples, the previous dates are a contiguous series of dates.

Phrased differently, the set of previous dates may include multiple dates with the same day of week as a day in which the cloud application is deployed and exclude dates having a different day of week as the day in which the cloud application is deployed. For example, the set of previous dates includes multiple Thursdays and excludes all other days if the cloud application is going to be deployed on a Thursday. The set of previous dates comprises a most recently completed two, three, four, or five dates that have the same day of week as the day in which the cloud application is deployed.

The rollout windows may be of different sizes, overlapping, or both. For example, the set of rollout windows may be defined as eight non-overlapping three-hour periods of a day or as twenty-four overlapping three-hour periods of the day. The set of rollout windows may provide full coverage of a twenty-four hour period or other amounts of coverage may be used (e.g., twelve hours or forty-eight hours). The coverage provided by the set of rollout windows may be continuous or discontinuous. For example, the set of rollout windows may cover the period of midnight to midnight for one day or 8 PM-8 AM for two nights.

The rollout windows may be aligned to the hours of the day. For example, the set of rollout windows may be composed of twenty-four rollout windows, each of the twenty-four rollout windows beginning at a different hour of a day. The twenty-four rollout windows may be one hour in duration each, two hours in duration each, three hours in duration each, four hours in duration each, six hours in duration each, eight hours in duration each, or any other duration. As another example, the set of rollout windows may be composed of eight rollout windows, each of the eight rollout windows beginning at midnight, 3 AM, 6 AM, 9 AM, noon, 3 PM, 6 PM, and 9 PM.

The maximum workload of the resource within the rollout window on the set of previous dates may be accessed from the historic usage table 310. For example, if the resource is the network NR-123, the set of rollout windows is the set of one-hour non-overlapping periods that completely cover the date of Nov. 21, 2024 (a Thursday), and the set of previous dates is the three preceding Thursdays, then data from the seventy-two one-hour non-overlapping periods that completely cover the dates of Oct. 31, 2024, Nov. 7, 2024, and Nov. 14, 2024 may be accessed from the historic usage table 310. The maximum workload data used in the method 700 may be the bytes ingress data from the historic usage table 310, the bytes egress data from the historic usage table 310, maximum CPU data, maximum memory data, or another usage measure. For example, the total ingress of requests during the period of time or the maximum ingress of requests during a sub-division of the period of time (e.g., one minute) may be used.

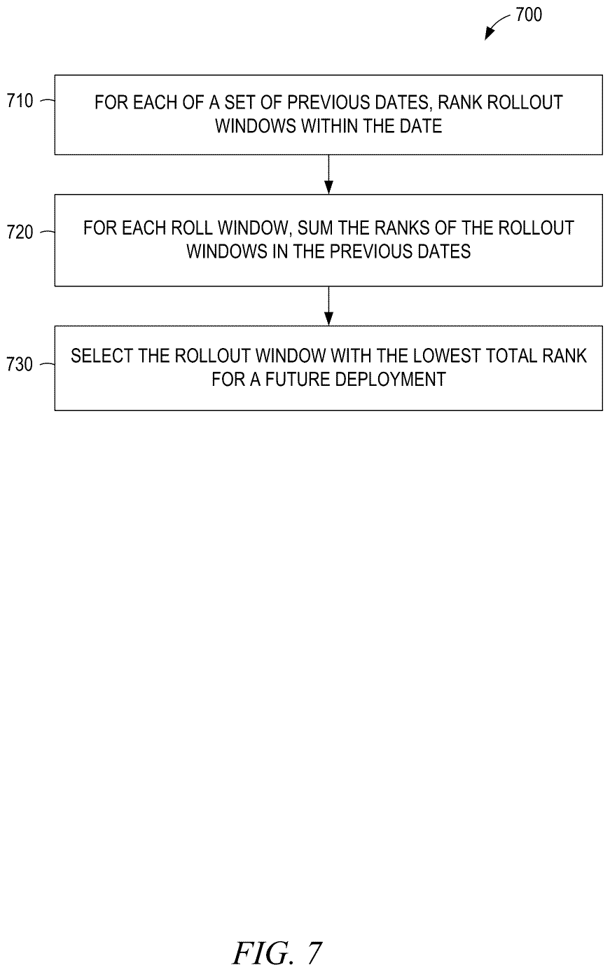

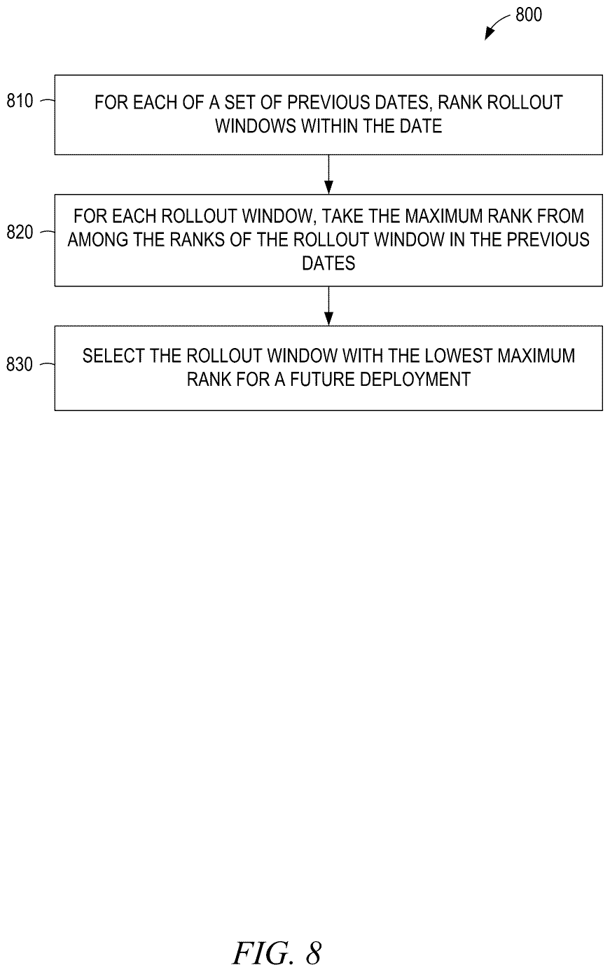

In operation 620, the broker provider 110 selects, based on the maximum workloads, a rollout window of the set of windows. Operation 620 may be performed using the method 700 of FIG. 7 or the method 800 of FIG. 8.

The broker provider 110, in operation 630, deploys a cloud application to the resource during the determined rollout window. Deployment of the cloud application may involve temporarily disabling the cloud application on the resource, routing requests to another resource, or any suitable combination thereof, which may degrade performance during the rollout window. However, using the method 600, resources are deployed to a cloud environment based on measured historic usage data, reducing the impact of the rollout. As a result, the cloud deployment process has improved reliability and scalability.

FIG. 7 is a flowchart illustrating operations of a method 700 for determining a rollout window for cloud software, according to some example embodiments. The method 700 includes operations 710, 720, and 730. By way of example and not limitation, the method 700 is described as being performed by the broker provider 110 of FIG. 1, in communication with the cloud service providers 120A-120B, realms 130A-130D, networks 140A-140H, container environments 220A-220B, physical clusters 230A-230D, and logical clusters 240A-240H, of FIGS. 1-2. The broker provider 110 uses the data structures of FIGS. 4-5. Prior to performing the method 700, historic usage data for a cloud application may be stored in a database, such as the database schema 300 of FIG. 3.

In operation 710, the broker provider 110 ranks rollout windows within each date of a set of previous dates. Continuing with the example of twenty-four one-hour rollout windows and the previous dates of Oct. 31, 2024, Nov. 7, 2024, and Nov. 14, 2024, the twenty-four hours of each date is ranked in the range of 1-24. An example of such a ranking is discussed above with relation to FIGS. 4-5.

In some example embodiments, a date is excluded from the set of previous dates based on the historic usage data for that date. For example, a difference between the highest and lowest maximum usage data values among the rollout windows for the date may be determined. If that difference, divided by the highest value, is less than a predetermined threshold (e.g., 10%, 20%, or 25%), a determination is made that the variance on the date is insignificant. Accordingly, the date is removed from the set of previous dates and operations 720 and 730 are performed based on the dates with significant variances.

The broker provider 110 sums the ranks of the rollout windows in operation 720 (as shown in the table 530 of FIG. 5). At this point, candidate rollout windows may be eliminated if the rank for any of the previous dates exceeds a predetermined threshold (e.g., 3). As a result, a rollout window with very low usage on most previous dates but very high usage on previous date will be eliminated from consideration.

In operation 730, the rollout window with the lowest aggregate rank is selected. In this example, a rollout window is selected for the day of the week that is the same as the days used in operation 710.

If all of the previous dates were eliminated in operation 710 or all rollout windows were eliminated in operation 720, operation 730 will not be able to select a rollout window. In such cases, a default rollout window may be used. The default rollout window may be selected based on the region and time zone of the resource to favor an overnight rollout. For example, a rollout window of Sunday 12 am-1 pm, 12 am-2 am, 12 am-4 am, or 12 am-6 am, in the resource's time zone, may be used.

Alternatively, instead of being a set of previous dates having the same day of week, the set of previous dates may include all days of the week. For example, twenty-one previous dates covering three weeks may be used in operation 710. As a result, in such embodiments, the method 700 operates to select a rollout window for all days of the week.

FIG. 8 is a flowchart illustrating operations of a method 800 for determining a rollout window for cloud software, according to some example embodiments. The method 800 includes operations 810, 820, and 830. By way of example and not limitation, the method 800 is described as being performed by the broker provider 110 of FIG. 1, in communication with the cloud service providers 120A-120B, realms 130A-130D, networks 140A-140H, container environments 220A-220B, physical clusters 230A-230D, and logical clusters 240A-240H, of FIGS. 1-2. The broker provider 110 uses the data structures of FIGS. 4-5. Prior to performing the method 800, historic usage data for a cloud application may be stored in a database, such as the database schema 300 of FIG. 3.

In operation 810, the broker provider 110 ranks rollout windows within each date of a set of previous dates. For this example, consider the data shown for Wednesday in the tables 510 and 520 of FIG. 5. The broker provider 110 takes, for each rollout window, the maximum rank from among the ranks of the rollout window in the previous dates in operation 820. Thus, in order of the five hours shown for Wednesday, the maximum ranks would be:

| Rollout Window | Maximum Rank |
|---|---|
| 00:00-1:00 | 5 |
| 1:00-2:00 | 4 |
| 2:00-3:00 | 5 |
| 3:00-4:00 | 4 |
| 23:00-00:00 | 3 |

In operation 830, the rollout window with the lowest maximum rank is selected. In this example, the rollout window of 23:00-00:00 is selected, since the maximum rank of 3 in that window is lower than the maximum rank for any other rollout window.

Alternatively, instead of being a set of previous dates having the same day of week, the set of previous dates may include all days of the week. For example, twenty-one previous dates covering three weeks may be used in operation 810. As a result, in such embodiments, the method 800 operates to select a rollout window for all days of the week.

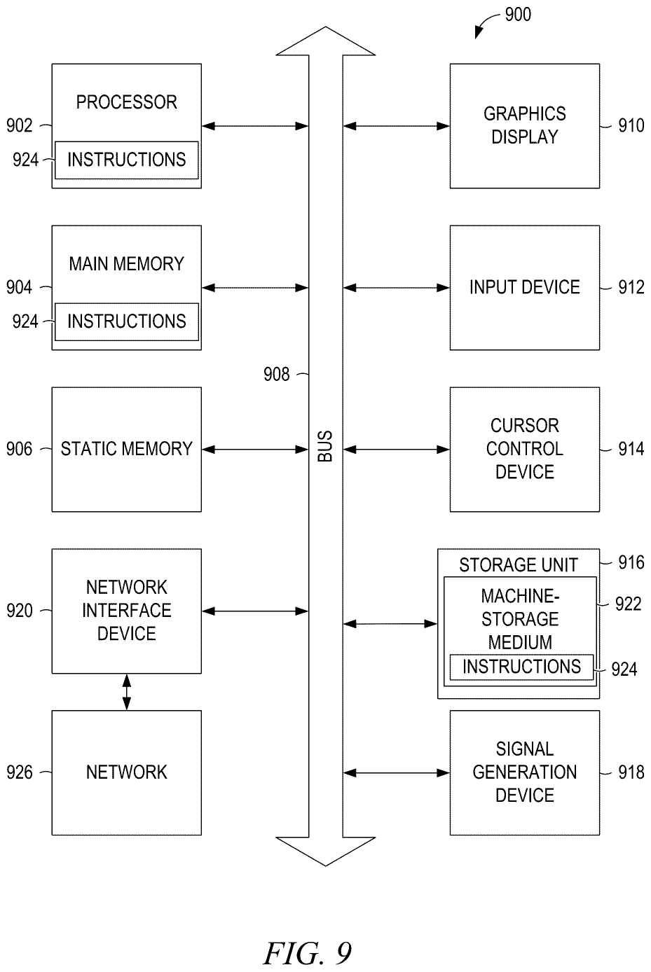

FIG. 9 illustrates components of a machine 900, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 9 shows a diagrammatic representation of the machine 900 in the example form of a computer device (e.g., a computer) and within which instructions 924 (e.g., software, a program, an application, an applet, an app, or other executable code) for causing the machine 900 to perform any one or more of the methodologies discussed herein may be executed, in whole or in part.

For example, the instructions 924 may cause the machine 900 to execute the flow diagrams of FIGS. 6-8. In one embodiment, the instructions 924 can transform the general, non-programmed machine 900 into a particular machine (e.g., specially configured machine) programmed to carry out the described and illustrated functions in the manner described.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a peer-to-peer (or distributed) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 924 (sequentially or otherwise) that specify actions to be taken by that machine. Further, while only a single machine is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, or a cathode ray tube (CRT), or any other display capable of displaying graphics or video). The machine 900 may also include an input device 912 (e.g., a keyboard), a cursor control device 914 (e.g., a mouse, a touchpad, a trackball, a joystick, a motion sensor, or other pointing instrument), a storage unit 916, a signal generation device 918 (e.g., a sound card, an amplifier, a speaker, a headphone jack, or any suitable combination thereof), and a network interface device 920.

The storage unit 916 includes a machine-storage medium 922 (e.g., a tangible machine-storage medium) on which is stored the instructions 924 (e.g., software) embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered as machine-storage media (e.g., tangible and non-transitory machine-storage media). The instructions 924 may be transmitted or received over a communication network 926 via the network interface device 920.

In some example embodiments, the machine 900 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (e.g., 904, 906, and/or memory of the processor(s) 902) and/or storage unit 916 may store one or more sets of instructions 924 and data structures (e.g., software) embodying or utilized by any one or more of the methodologies or functions described herein. These instructions, when executed by processor(s) 902 cause various operations to implement the disclosed embodiments.

As used herein, the terms “machine-storage medium,” “device-storage medium,” “computer-storage medium” (referred to collectively as “machine-storage medium 922”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage medium 922 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The machine-storage medium 922 specifically excludes carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 924 may further be transmitted or received over a communication network 926 using a transmission medium via the network interface device 920 and utilizing any one of a number of well-known transfer protocols (e.g., HTTP). Examples of communication networks 926 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 924 for execution by the machine 900, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

In view of the disclosure above, various examples are set forth below. It should be noted that one or more features of an example, taken in isolation or combination, should be considered within the disclosure of this application.

### Examples

Example 1 is a system comprising: one or more hardware processors; and a memory that stores instructions that, when executed by the one or more hardware processors, cause the one or more hardware processors to perform operations comprising: determining, for a set of rollout windows, a maximum workload of a resource within the rollout window on a set of previous dates; selecting, based on the maximum workloads, a rollout window of the set of rollout windows; and deploying a cloud application to the resource during the selected rollout window.

In Example 2, the subject matter of Example 1, wherein the set of rollout windows comprises twenty-four rollout windows, each of the twenty-four rollout windows beginning at a different hour of a day.

In Example 3, the subject matter of Example 2, wherein each of the twenty-four rollout windows has a one-hour duration.

In Example 4, the subject matter of any one or more of Examples 2-3, wherein each of the twenty-four rollout windows has a two-hour duration.

In Example 5, the subject matter of any one or more of Examples 1-4, wherein the set of previous dates comprises a plurality of dates that have a same day of week as a day in which the cloud application is deployed and excludes dates having a different day of week as the day in which the cloud application is deployed.

In Example 6, the subject matter of Example 5, wherein the set of previous dates comprises a most recently completed three dates that have the same day of week as the day in which the cloud application is deployed.

In Example 7, the subject matter of any one or more of Examples 1-6, wherein the operations further comprise: ranking, for each of the previous dates, the rollout windows based on the maximum workload of the resource during each rollout window; determining, for each rollout window, a sum of the ranks during the rollout window on the set of previous dates; wherein the selecting of the rollout window comprises selecting the rollout window having the lowest sum of the ranks among the sums determined for each rollout window.

In Example 8, the subject matter of any one or more of Examples 1-7, wherein the selecting of the rollout window comprises determining a rollout window for a day of a week.

In Example 9, the subject matter of any one or more of Examples 1-8, wherein the selecting of the rollout window comprises determining a single rollout window for all days of a week.

Example 10 is a method comprising: determining, by one or more hardware processors and for a set of rollout windows, a maximum workload of a resource within the rollout window on a set of previous dates; selecting, based on the maximum workloads, a rollout window of the set of rollout windows; and deploying a cloud application to the resource during the selected rollout window.

In Example 11, the subject matter of Example 10, wherein the set of rollout windows comprises twenty-four rollout windows, each of the twenty-four rollout windows beginning at a different hour of a day.

In Example 12, the subject matter of Example 11, wherein each of the twenty-four rollout windows has a one-hour duration.

In Example 13, the subject matter of any one or more of Examples 11-12, wherein each of the twenty-four rollout windows has a two-hour duration.

In Example 14, the subject matter of any one or more of Examples 10-13, wherein the set of previous dates comprises a plurality of dates that have a same day of week as a day in which the cloud application is deployed and excludes dates having a different day of week as the day in which the cloud application is deployed.

In Example 15, the subject matter of any one or more of Example 14, wherein the set of previous dates comprises a most recently completed three dates that have the same day of week as the day in which the cloud application is deployed.

In Example 16, the subject matter of any one or more of Examples 10-15 includes ranking, for each of the previous dates, the rollout windows based on the maximum workload of the resource during each rollout window; determining, for each rollout window, a sum of the ranks during the rollout window on the set of previous dates; wherein the selecting of the rollout window comprises selecting the rollout window having the lowest sum of the ranks among the sums determined for each rollout window.

In Example 17, the subject matter of any one or more of Examples 10-16, wherein the selecting of the rollout window comprises determining a rollout window for a day of a week.

Example 18 is a storage medium comprising instructions that, when executed by one or more hardware processors of a machine, cause the machine to perform operations comprising: determining, for a set of rollout windows, a maximum workload of a resource within the rollout window on a set of previous dates; selecting, based on the maximum workloads, a rollout window of the set of rollout windows; and deploying a cloud application to the resource during the selected rollout window.

In Example 19, the subject matter of Example 18, wherein the set of rollout windows comprises twenty-four rollout windows, each of the twenty-four rollout windows beginning at a different hour of a day.

In Example 20, the subject matter of Example 19, wherein each of the twenty-four rollout windows has a one-hour duration.

Example 21 is an apparatus comprising means to implement of any of Examples 1-20.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

1. A system comprising:
one or more hardware processors; and
a memory that stores instructions that, when executed by the one or more hardware processors, cause the one or more hardware processors to perform operations comprising:
determining, for each rollout window of a set of rollout windows, a maximum workload of a resource within the rollout window on a set of previous dates;
ranking, for each of the previous dates, each of the rollout windows of the set of rollout windows based on the maximum workload of the resource during the rollout window;
determining, for each rollout window of the set of rollout windows, a sum of the ranks during the rollout window on the set of previous dates;
selecting, based on the maximum workloads, a rollout window of the set of rollout windows having a lowest sum of the ranks among the sums determined for each rollout window of the set of rollout windows; and
based on the selection of the rollout window, deploying a cloud application to the resource during the selected rollout window.

2. The system of claim 1, wherein the set of rollout windows comprises twenty-four rollout windows, each of the twenty-four rollout windows beginning at a different hour of a day.

3. The system of claim 2, wherein each of the twenty-four rollout windows has a one-hour duration.

4. The system of claim 2, wherein each of the twenty-four rollout windows has a two-hour duration.

5. The system of claim 1, wherein the set of previous dates comprises a plurality of dates that have a same day of week as a day in which the cloud application is deployed and excludes dates having a different day of week as the day in which the cloud application is deployed.

6. The system of claim 5, wherein the set of previous dates comprises a most recently completed three dates that have the same day of week as the day in which the cloud application is deployed.

7. (canceled)

8. The system of claim 1, wherein the selecting of the rollout window comprises determining a rollout window for a day of a week.

9. The system of claim 1, wherein the selecting of the rollout window comprises determining a single rollout window for all days of a week.

10. A method comprising:
determining, by one or more hardware processors and for each rollout window of a set of rollout windows, a maximum workload of a resource within the rollout window on a set of previous dates;
ranking, for each of the previous dates, each of the rollout windows of the set of rollout windows based on the maximum workload of the resource during the rollout window;
determining, for each rollout window of the set of rollout windows, a sum of the ranks during the rollout window on the set of previous dates;
selecting, based on the maximum workloads, a rollout window of the set of rollout windows having a lowest sum of the ranks among the sums determined for each rollout window of the set of rollout windows; and
based on the selection of the rollout window, deploying a cloud application to the resource during the selected rollout window.

11. The method of claim 10, wherein the set of rollout windows comprises twenty-four rollout windows, each of the twenty-four rollout windows beginning at a different hour of a day.

12. The method of claim 11, wherein each of the twenty-four rollout windows has a one-hour duration.

13. The method of claim 11, wherein each of the twenty-four rollout windows has a two-hour duration.

14. The method of claim 10, wherein the set of previous dates comprises a plurality of dates that have a same day of week as a day in which the cloud application is deployed and excludes dates having a different day of week as the day in which the cloud application is deployed.

15. The method of claim 14, wherein the set of previous dates comprises a most recently completed three dates that have the same day of week as the day in which the cloud application is deployed.

16. (canceled)

17. The method of claim 10, wherein the selecting of the rollout window comprises determining a rollout window for a day of a week.

18. A non-transitory machine-storage medium comprising instructions that, when executed by one or more hardware processors of a machine, cause the machine to perform operations comprising:
determining, for each rollout window of a set of rollout windows, a maximum workload of a resource within the rollout window on a set of previous dates;
ranking, for each of the previous dates, each of the rollout windows of the set of rollout windows based on the maximum workload of the resource during the rollout window;
determining, for each rollout window of the set of rollout windows, a sum of the ranks during the rollout window on the set of previous dates;
selecting, based on the maximum workloads, a rollout window of the set of rollout windows having a lowest sum of the ranks among the sums determined for each rollout window of the set of rollout windows; and
based on the selection of the rollout window, deploying a cloud application to the resource during the selected rollout window.

19. The non-transitory machine-storage medium of claim 18, wherein the set of rollout windows comprises twenty-four rollout windows, each of the twenty-four rollout windows beginning at a different hour of a day.

20. The non-transitory machine-storage medium of claim 19, wherein each of the twenty-four rollout windows has a one-hour duration.

21. The non-transitory machine-storage medium of claim 19, wherein each of the twenty-four rollout windows has a two-hour duration.

22. The non-transitory machine-storage medium of claim 18, wherein the set of previous dates comprises a plurality of dates that have a same day of week as a day in which the cloud application is deployed and excludes dates having a different day of week as the day in which the cloud application is deployed.
